(19) United States
(12) Patent Application Publication
(10) Pub. No.: US 2026/0002392 A1
(43) Pub. Date: Jan. 1, 2026

(54) LOCK HOLDER FOR A MOTOR VEHICLE DOOR LOCK

(71) Applicant: Kiekert Aktiengesellschaft, Heiligenhaus (DE)

(72) Inventors: Ömer INAN, Dorsten (DE); Peter SZEGENY, Engelskirchen (DE); Michael SCHOLZ, Essen (DE); Holger SCHIFFER, Meerbusch (DE); Andreas SCHMITZ, Velbert (DE); Thorsten BENDEL, Oberhausen (DE)

(73) Assignee: Kiekert Aktiengesellschaft, Heiligenhaus (DE)

(21) Appl. No.: 18/881,439

(22) PCT Filed: Jun. 5, 2023
(86) PCT No.: PCT/DE2023/100423

§ 371 Date: Jan. 6, 2025

(30) Foreign Application Priority Data
Jul. 11, 2022 (DE) 10 2022 117 245.7

(51) Int. Cl. E05B 85/04

(52) U.S. Cl. CPC E05B 85/045

(57) ABSTRACT

The invention relates to a lock holder (1) for a motor vehicle door lock comprising a lock holder plate (2), a locking bolt (3), a center piece (4) and a connecting bolt (5), the lock holder (1) comprising a separate locking bolt (3) and a separately formed connecting bolt (5).

The invention relates to a lock holder for a motor vehicle door lock comprising a lock plate, a locking bolt, a center piece and a connecting bolt, the lock holder comprising a separate locking bolt.

The lock holder generally interacts with a locking mechanism of an associated motor vehicle door lock. The lock holder and motor vehicle door lock generally define the motor vehicle door locking means. In conjunction with the locking mechanism in the motor vehicle door lock, the lock holder ensures a secure and reliable closure of the associated motor vehicle door. For this purpose, the lock holder is usually connected to a motor vehicle body, for example a B or C pillar of the associated motor vehicle body. The motor vehicle door lock, on the other hand, is located in the motor vehicle door to be locked. In principle, this can also be reversed.

Due to the primary closing function of the lock holder in conjunction with the locking mechanism in the motor vehicle door lock, it is, on the one hand, a particularly safety-relevant component which, on the other hand, is exposed to particular loads in particular in the event of an accident. In fact, the protection of vehicle occupants in the event of a side impact depends substantially on how reliably the lock holder and the locking mechanism interacting therewith are capable of absorbing the forces acting thereon. The primary concern here is that the motor vehicle door remains closed so that safety devices provided in or on the motor vehicle door, such as a brake assistant, side airbags, side impact protection, etc., can have the desired effect.

The forces to be absorbed via the interaction between the motor vehicle door lock and the lock holder act directly between the locking mechanism contained in the motor vehicle door lock and the locking pin of the lock holder bracket which engages with the locking mechanism. The locking mechanism is formed by a catch and at least one pawl, wherein after engagement of the catch, during a closing movement of the door element, a pawl engages in the catch in the striker of the lock holder and prevents the door element from opening.

The locking mechanism may have a pre-ratchet and a main ratchet which can be present in the door lock depending on the door element. Depending on the embodiment of the locking mechanism, the particular latch position, i.e., main ratchet or pre-ratchet, can be provided with an opening or closing moment, so that a blocking lever can be used to secure the latch position. In order to be able to absorb the high forces that occur in the event of an accident, the locking mechanism parts are made at least in part from a metal material, mounted in metal shafts and held on a metal lock plate in the vehicle door lock.

In the prior art, various approaches have already been pursued to further develop such lock holders so that they can absorb far more forces than before in the event of a crash, without tearing off or general mechanical damage occurring or being able to occur. In fact, with regard to the lock holder, material deformations and tears are often observed in practice, in particular at the transition from the lock holder bracket to the lock holder plate.

In order to reach the forces which can be absorbed by the lock holder, various approaches have become known. There are various approaches to providing the lock holder or its lock holder bracket with different cross-sectional thicknesses, as described for example in EP 2 031 158 A2, or to specify an elongation of the lock holder by means of an indentation, as disclosed for example in DE 10 2010 021 677 A1. However, this does not adequately reflect the loads which actually occur in practice and the associated deformation behavior of the lock holder in the event of a crash or extreme forces. It has become apparent that the connection between the lock holder bracket and the lock holder plate is particularly important.

DE 10 2014 006 857 A1 discloses a lock holder for a motor vehicle door lock, which lock holder has a lock holder plate and a lock holder bracket attached thereto, wherein the lock holder bracket is designed with a locking pin, a central piece and a connecting pin. To strengthen the connection between the lock holder bracket and the lock holder plate, the publication proposes that the lock holder bracket be positively connected to the lock holder plate via at least one material-thickened region. To ensure a positive connection, the part of the lock holder bracket or the locking pin and/or the connecting pin which protrudes beyond the lock holder plate is compressed. As a result of the compression process, the lock holder plate is also provided with a bulge which ensures that compression caps created on the underside of the lock holder plate as a result of the compression process can abut at a distance from the locking pin on the one hand and the connecting pin on the other hand in relation to the body.

The solutions known from the prior art have generally proven themselves, but are reaching their limits with newer developments in the automotive industry. The use of batteries in hybrid or electric vehicles increases the loads on the motor vehicle door lock caused in the event of an accident. The batteries present in the motor vehicle increase the total weight of the vehicle many times over, so that the loads on the locking mechanism and the lock holder in the event of an accident are also increased. Consequently, approaches must be found to increase the strength of the lock holder. This is where the invention comes in.

The object of the invention is to provide an improved lock holder for a motor vehicle door lock. In particular, it is an object of the invention to improve the load capacity of the lock holder and to increase the tear resistance of the system consisting of the lock and the lock holder.

According to the invention, the object is achieved by the features of independent claim 1. Advantageous embodiments of the invention are specified in the dependent claims. It should be noted, however, that the exemplary embodiments described below are not restrictive; rather, any variation of the features described in the description and the dependent claims is possible.

According to claim 1, the object of the invention is achieved in that a lock holder for a motor vehicle door lock is provided, comprising a lock holder plate, a locking bolt, a center piece and a connecting bolt, the lock holder comprising a separate locking bolt, and wherein the lock holder additionally has a separately formed connecting bolt. The design according to the invention of the lock holder now makes it possible to design the lock holder bracket so that it can be individually adapted to the loads and, in particular, to the extreme loads in the event of an accident. The individual loads in the event of an accident are particularly relevant to safety, as it must be ensured that the doors, flaps or hoods remain closed, in particular in the event of an accident. The side doors are particularly important because the occupants of the motor vehicle must be protected. Other safety systems, such as a brake assistant, seatbelts, airbags, etc. can only be fully effective when the door is securely closed. Due to the design of the lock holder according to the invention and in particular due to the separate design of the connecting bolt, the lock holder can be adapted to the specifications of the motor vehicle manufacturer with an individual adaptation of the connecting bolt.

In the event of an accident in particular, the locking system consisting of the motor vehicle lock and lock holder is exposed to extreme loads. These loads are simulated during the release of the locking system, including in tensile tests and tear tests. The lock holder is subjected to a tensile test until it breaks in order to determine whether the defined specifications are met and to identify weak points. The design according to the invention of the lock holder now makes it possible to design the lock holder so that it can be individually adapted to the loads.

As already indicated above, the lock holder according to the invention does not only relate to a side door, but can also be used in the region of a hood, tailgate, sliding door, cover, foldable seats, etc. Use is conceivable wherever components arranged pivotally or displaceably on the motor vehicle have to be held securely in their position.

Basically, the lock holder has a lock holder plate. The lock holder plate is usually screwed to the body or the movable component by means of two screws so that an interaction between the lock holder and the motor vehicle lock is possible. The lock holder plate can additionally have a bevel so that any provided rivet heads of the other components of the lock holder can be accommodated in the bevel so that at least a partial region of the lock holder plate can be secured flat to the body. The bevel then accommodates the corresponding rivet heads of the other components of the lock holder.

The lock holder also has a locking bolt, a center piece and a connecting bolt. These components together form a bracket shape so that these components can also be referred to as a lock holder bracket. According to the invention, the components, locking bolt, center piece and connecting bolt are designed as separate components and connected to one another during mounting. The arrangement, describable as a bracket shape, of the locking bolt, the center piece and the connecting bolt forms an opening through which a locking mechanism of a motor vehicle lock can interact with the lock holder. In this case, a locking mechanism arranged in the motor vehicle lock consisting of a catch and at least one pawl is moved relative to the lock holder in such a way that the catch can move around the locking bolt, after which a pawl subsequently locks the catch in its engaged position.

Depending on the application of the motor vehicle lock or the lock holder, a pre-ratchet position and/or a main ratchet position can be assumed here. In the ratchet position, the catch encloses the locking bolt. If there is an extreme load on the locking system in one of these ratchet positions, the catch moves over the locking bolt until the catch comes into contact with the center piece of the lock holder. Depending on the force acting on the locking system, the loaded side door, for example, must withstand the tearing forces and prevent the side door from opening. Due to the increased or ever-increasing requirements on the locking system, an adaptation of the lock holder to these increased requirements is necessary. The design according to the invention of the lock holder with a separate locking bolt and a separate connecting bolt allows individual adaptation to the increased and ever-increasing loads.

A further increase in the operational reliability of the locking system can be achieved if the locking bolt and/or the connecting bolt has an enlarged cross section in a contact region with the lock holder plate. Due to the increased cross section, the contact surface of the locking bolt or the connecting bolt can be enlarged in the direction of the lock holder plate. This can increase the overall load capacity of the lock holder and thus increase the safety of the motor vehicle. A thickening of the lock holder bracket in the region of the lock holder plate makes it possible to increase the load capacity of the lock holder bracket. By increasing the cross section in the base region of the locking bolt and/or the connecting bolt, the contact surface on the mounting plate or the lock holder plate can be maximized. Maximizing the contact surface increases the resistance to bending stress. Bending stress can act on the locking bolt in particular in the transverse direction of the vehicle and/or in a vertical direction. Typically, a coordinate system is placed in a motor vehicle for design purposes. The x-axis represents the longitudinal direction of the vehicle, the y-axis represents the transverse direction of the vehicle, and the z-axis represents a vertical axis in relation to the motor vehicle or the ground below the motor vehicle. The bending stress can thus be increased in particular in the y- and z-directions.

It has proven to be particularly advantageous if the locking bolt and/or the connecting bolt have a cross-sectional area continuously increasing towards the contact region. Usually, the locking bolt is designed cylindrical, i.e., the locking bolt has a circular cross-sectional shape. Likewise, according to the invention, the connecting bolt is designed round, i.e., the connecting bolt also has a circular cross-sectional shape. At least the locking bolt has an engagement region for the catch, wherein the engagement region for the catch has a uniform diameter. In other words, the engagement region for the catch is equipped with a uniform diameter. Starting from the engagement region and viewed in the direction of the lock holder plate, the cross-sectional shape increases continuously according to the invention so that a conical enlargement of the projection area results in a plan view of the locking bolt and/or the connecting bolt. In other words, the locking bolt and/or connecting bolt is designed at least partially cylindrical and in turn at least partially conical. The enlargement, i.e., the conical region of the locking bolt or the connecting bolt, extends in such a way that the contact surface of the locking bolt and/or the connecting bolt increases towards the lock holder plate.

In a further embodiment variant of the invention, the center piece is designed flat at least in a mounting region towards the locking bolt and/or the connecting bolt. In this context, “flat” means that the center piece in the mounting region has a cross-sectional shape that can be described as rectangular. The flat or rectangular design of the center piece in the mounting region for the locking bolt and/or the connecting bolt allows for easy mounting of the center piece, wherein cold forming is preferably used to connect the center piece to the locking bolt and/or the connecting bolt. This also again allows for individual adaptation to the load capacity of the lock holder. Depending on the requirements of the lock holder, the connecting region of the center piece can be designed flat and the region between the mounting regions can be designed round or oval, for example, in order to achieve additional stabilization of the lock holder as a whole.

However, it can also be advantageous if the center piece is designed flat so that the center piece as a whole has a rectangular cross-sectional shape. An overall design of the center piece in the form of a rectangular cross-sectional shape is advantageous from a structural and manufacturing point of view. On the one hand, a flat center piece is easy and inexpensive to produce and, on the other hand, it can simplify the handling of the center piece. The center piece can then be punched out as a sheet metal strip, for example, and can also be called a mounting plate. For example, holes can then be inserted into the mounting plate or the center piece, wherein the holes can serve to accommodate the locking bolt or the connecting bolt so that, for example, cold forming of extensions through the mounting plate is possible.

If the locking bolt has a material thickening in a mounting region for the center piece, an advantageous embodiment variant of the invention is achieved. By means of the material thickening, the contact surface between the locking bolt and the center piece, in particular the flattened region of the center piece, can be enlarged so that the bending resilience can be increased. The material thickening in the region of the center piece increases the bending resilience. In addition, the material thickening can advantageously increase the contact surface when riveting the locking bolt so that, additionally, a contact surface is available for riveting or forming the locking bolt. According to the invention, the material thickening of the locking bolt in the connecting region to the center piece forms a contact surface for the catch. The design according to the invention of the locking bolt, which additionally provides a contact surface for the catch, also allows the load capacity of the lock holder to in turn be increased.

As tests have shown, the contact of the catch results in a load distribution from the locking bolt to the catch. Because the catch is engaged with the locking bolt not only via the load arm but also via the collar formed by the thickening, i.e., there is at least partially contact of the circumference of the locking bolt by the catch, the force from the load arm can additionally be transmitted to the catch arm of the catch. The load arm of the catch is relieved, and the tear resistance in the x-direction, i.e., in the longitudinal direction of the motor vehicle, is improved. If usually only the load arm rests on the locking bolt, wherein the load arm grips around the locking bolt, the contact surface between the catch and the locking bolt can exert lateral transmission of force between the catch and locking bolt by means of the crash collar designed according to the invention. In other words, the catch additionally rests on the side of the crash collar, i.e. the thickening, which in particular increases the tear resistance. The crash collar or the material thickening can be designed as a flat contact surface on the locking bolt.

As already explained above, the formation of the material thickening on the locking bolt as a collar can result in an additional increase in the strength of the locking system. The formation of a collar on the locking bolt means that not only the center piece is available as a contact surface for the catch, but that the catch at least partially rests on the circumference of the collar. This provides a load distribution over the contact region of the catch on the collar of the locking bolt, wherein depending on the size of the collar, the contact surface on the catch can be adapted, and can accordingly be adapted to the requirements. Depending on the load to be absorbed, i.e., the requirements to which the locking system can be exposed, the collar can have different diameters. Preferably, the collar is formed circumferentially on the locking bolt, which is also cylindrical, i.e., has an at least partially uniform diameter. The collar forms a flat contact surface for the catch.

Advantageously, the collar and/or the catch has a plastics coating in a contact region of the catch on the collar. A plastics coating offers the advantage that noise minimization can be achieved if there is an interaction between the catch and the collar during operation of the motor vehicle. Shocks and/or vibrations in the motor vehicle can cause the catch to contact the collar of the locking bolt and thereby give rise to an interaction between the catch and the collar. With a plastics coating at least partially on the collar and/or the catch in the contact region, easy interaction of the friction partners can be achieved in an advantageous manner, and noise emission can be prevented.

It can also be advantageous and an embodiment variant of the invention if the locking bolt and/or the connecting bolt is designed as a rivet bolt. The locking bolt and/or the connecting bolt can be formed as separate components and connectable to the lock holder plate and the center piece. One advantageous joining method in this context is cold forming the locking bolt and/or the connecting bolt so that sufficient strength can be achieved in the lock holder. The riveting method can also be easily integrated into a manufacturing process of the lock holder.

The locking bolt and/or the connecting bolt can be manufactured as individual parts, for example as stamped parts. In this context, the locking bolt and/or the connecting bolt in the form of a rivet bolt have a bevel at least at the end and before riveting, which can serve as a contact surface on the lock holder and/or on the center piece. The lock holder plate and the center piece are then equipped with corresponding holes so that the components designed as rivet bolts can be easily connected to the center piece and the lock holder plate. The contact surfaces on the rivet bolts then simultaneously form the counter bearings for cold forming, i.e., riveting. The lock holder produced according to the invention has an increased bending strength in the y- and z-direction and an increased tear resistance in the x-direction of the motor vehicle and can thereby meet the requirements of the automobile manufacturers. In particular, the increased requirements for tear resistance and overall bending strength can be met.

Finally, the locking bolt and the connecting bolt can also be designed symmetrically. Symmetry offers the advantage of allowing for cost-effective production on the one hand and simplifying mounting on the other hand.

In the following, the invention is explained in more detail with reference to the appended drawings using an exemplary embodiment. However, the principle applies that the exemplary embodiment does not limit the invention, but is merely an advantageous embodiment of the invention. The features depicted can be implemented individually or in combination with further features of the description as well as what is claimed-individually or in combination.

### IN THE FIGURES

FIG. 1 is a side view of a lock holder designed according to the invention,

FIG. 2 is a detailed view of the components of the lock holder designed according to the invention according to FIG. 1, and

FIG. 3 is a plan view of the lock holder designed according to the invention according to the arrow Ill in FIG. 1 in interaction with a locking mechanism.

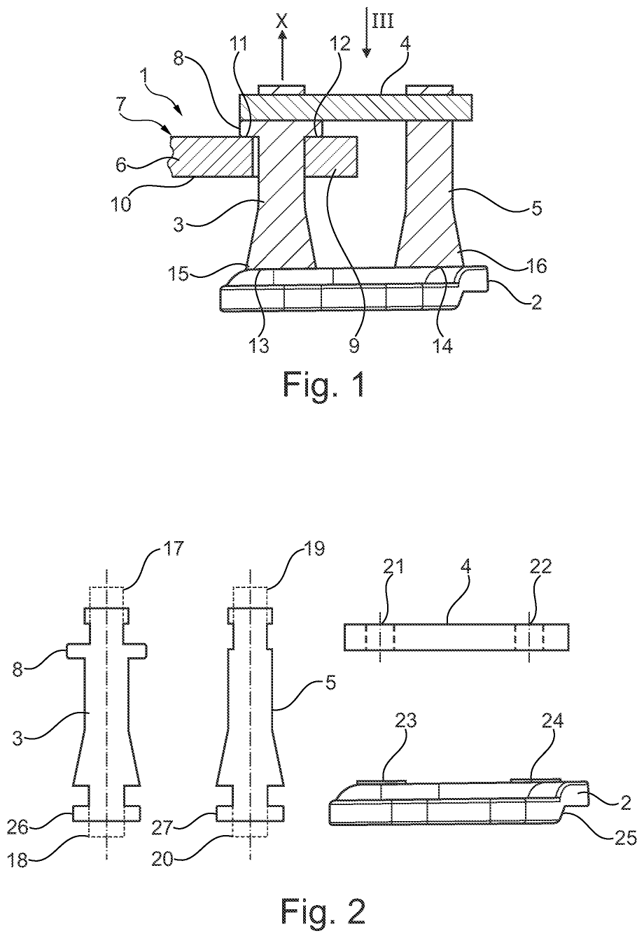

FIG. 1 is a side view of a lock holder 1 designed according to the invention. The lock holder 1 has a lock holder plate 2, a locking bolt 3, a center piece 4 and a connecting bolt 5. Also shown is a catch 16 as part of a locking mechanism 7. The catch 6 is in engagement with the locking bolt 3 so that the exemplary embodiment represents, for example, a main ratchet position of the locking mechanism 7 in interaction with the lock holder 1.

It can be clearly seen in FIG. 1 that the catch 6 rests against a collar 8 on the locking bolt 3. The catch 6 with a load arm 9 and a catch arm 10 comes into contact with the collar 8. Consequently, the design according to the invention of the locking bolt 3 provides a contact region 11, 12 for the catch 6, which clearly shows that a flat contact of the catch 6 on the collar 8 is possible. This allows a load distribution from the catch 6 to the collar and consequently to the locking bolt. Without the collar 8, the catch 6 would rest on the center piece 4, wherein only the load arm 9 could be accommodated for transmitting a force in the longitudinal direction of the motor vehicle, i.e., in the x-direction of the motor vehicle. By using a collar 8 on the locking bolt 3 according to the invention, a load distribution can be carried out, which in turn leads to an increase in the strength of the locking system consisting of the motor vehicle lock and the lock holder 1.

Furthermore, it can be seen that the locking bolt 3 and the connecting bolt 5 have different, i.e., changing diameters. The continuously increasing diameters on the locking bolt and on the center piece allow for an enlarged contact region 13, 14 on the locking bolt and connecting bolt 5. In other words, the locking bolt 3 and the connecting bolt 5 are designed reinforced in the base region 15, 16 in order to maximize the contact surface of the bolts on the lock holder plate 2. By maximizing the contact surface 13, 14, the resistance of the bolts 3, 5 to bending stress increases, in particular in the y- and z-direction of the motor vehicle.

In FIG. 2, the individual parts of the lock holder 1 are shown as separate components. Identical components are provided with the same reference signs. The locking bolt 3 has a collar 8, wherein the collar 8 also simultaneously serves as a counter bearing for riveting the locking bolt 3 to the center piece 4. The initial shape 17, 18, 19, 20 of the rivet bolts 3, 5 is shown as a dashed line in FIG. 2. The rivet bolts 3, 5 or the locking bolt and the connecting bolt 5 can be connected in their initial shape 17, 18, 19, 20 to the lock holder plate 2 and the center piece 4. For this purpose, for example, the holes 21, 22 into which the initial shapes 17, 18 can be inserted in order to ultimately connect the rivet bolts 3, 5 to the center piece 4 are also shown as a hidden line in the center piece 4. There are also two holes 23, 24 in the lock holder plate into which the initial shapes 19, 20 of the rivet bolts 3, 5 can be inserted. As can be clearly seen, the lock holder plate 2 has a shoulder 25 so that the rivet heads 26, 27 can be received in the shoulder 25.

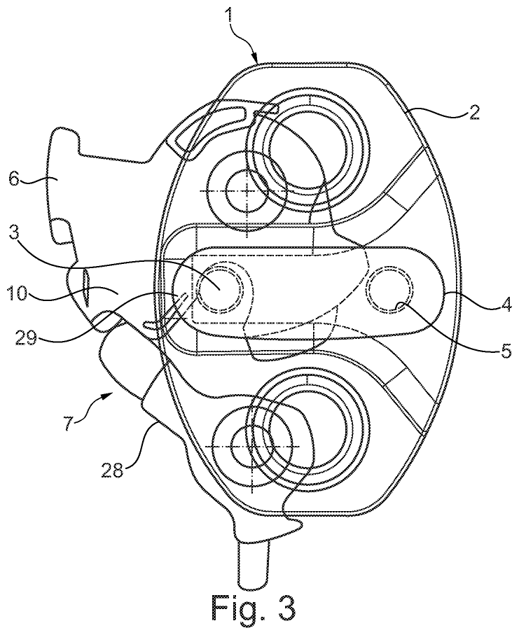

FIG. 3 shows the interaction of the locking mechanism 7 with the lock holder 1. The locking mechanism 7 is shown in a main ratchet position, wherein a pawl 28 locks the catch 6 in the main ratchet position. The function of such a locking mechanism 7 in interaction with a lock holder 1 is fully known. According to the invention, in interaction with the locking bolt 3 and in particular the projection 29 of the collar 8 over the catch arm 10, a load distribution can take place from the catch 6 to the lock holder 1. The load distribution on the catch arm 10 and load arm 9 thereby allows an increase in the load capacity of the locking system and an overall increase in the tear resistance and/or bending strength of the lock holder 1.

### LIST OF REFERENCE SIGNS

1 Lock holder
2 Lock holder plate
3 Locking bolt
4 Center piece
5 Connecting bolt
6 Catch
7 Locking mechanism
8 Collar
9 Load arm
10 Catch arm
11, 12, 13, 14 Contact region
15, 16 Base
17, 18, 19, 20 Initial shape
21, 22, 23, 24 Hole
25 Shoulder
26, 27 Rivet head
28 Pawl
29 Projection

1. A lock holder for a motor vehicle door lock, the lock holder comprising:
a lock holder plate,
a locking bolt,
a center piece, and
a connecting bolt,
wherein the locking bolt and the connecting bolt are separately formed.

2. The lock holder according to claim 1, wherein at least one of the locking bolt and the connecting bolt includes an increased cross section in a contact region with the lock holder plate.

3. The lock holder according to claim 2, wherein at least one of the locking bolt and the connecting bolt includes a cross-sectional area continuously increasing towards the contact region.

4. The lock holder according to claim 1, wherein the center piece is flat at least in a mounting region for the locking bolt and/or the connecting bolt.

5. The lock holder according to claim 1, wherein the center piece is designed flat such that a cross-sectional area of the center piece as a whole has a rectangular cross-sectional shape.

6. The lock holder according to claim 1, wherein the locking bolt has a material thickening in a mounting region for the center piece.

7. The lock holder according to claim 6, wherein the material thickening forms a contact surface for a catch of the motor vehicle door lock.

8. The lock holder according to claim 7, wherein the material thickening is a collar that forms the contact surface.

9. The lock holder according to claim 8, wherein at least one of the collar and the catch includes a plastics coating in a contact region of the catch on the collar.

10. The lock holder according to claim 1, wherein at least one of the locking bolt and the connecting bolt is a rivet bolt.

11. The lock holder according to claim 10, wherein the rivet bolt includes a rivet head with a bevel.

12. The lock holder according to claim 10, wherein at least one of the center piece and the lock holder plate includes at least one rivet hole.

13. The lock holder according to claim 1, wherein at least a portion of the locking bolt is cylindrical.

14. The lock holder according to claim 1, wherein at least one of the locking bolt and the connecting bolt is configured to be connected to at least one of the center piece and the lock holder plate via cold forming.

15. The lock holder according to claim 1, wherein the locking bolt and the connecting bolt are symmetrical.

16. A motor vehicle lock comprising:
the lock holder according to claim 1, and
a catch,
wherein the locking bolt has a material thickening in a mounting region for the center piece.

17. The motor vehicle lock according to claim 16, wherein the material thickening forms a contact surface for the catch.

18. The motor vehicle lock according to claim 17, wherein the material thickening is a collar that forms the contact surface.

19. The lock holder according to claim 18, wherein at least one of the collar and the catch includes a plastics coating in a contact region of the catch on the collar.
